(19) United States
(12) Patent Application Publication
(10) Pub. No.: US 2025/0066580 A1
(43) Pub. Date: Feb. 27, 2025

(54) POLYMER COMPOSITIONS WITH ANTIMICROBIAL NANOPARTICLES AND METHODS OF MANUFACTURE

(71) Applicant: EVOQ NANO, INC., Salt Lake City, UT (US)

(72) Inventor: William H. NIEDERMEYER, West Jordan, UT (US)

(21) Appl. No.: 18/942,262

(22) Filed: Nov. 8, 2024

Related U.S. Application Data
(63) Continuation-in-part of application No. 18/630,239, filed on Apr. 9, 2024.
(60) Provisional application No. 63/565,445, filed on Mar. 14, 2024.
(60) Provisional application No. 63/460,813, filed on Apr. 20, 2023.
(60) Provisional application No. 63/458,391, filed on Apr. 10, 2023.

(51) Int. Cl. C08K 3/08; C08J 3/20; C08J 5/00

(52) U.S. Cl. CPC C08K 3/08; C08J 3/203; C08J 5/005; C08J 2323/04; C08K 2003/0806; C08K 2201/005

(57) ABSTRACT

Disclosed are polymer compositions incorporating metal nanoparticles and medical devices or other products made therefrom. The disclosed polymer compositions can be utilized to form medical devices, including implantable medical devices, with effective antimicrobial properties. The disclosed polymer compositions incorporate metal nanoparticles that function without the release of metal (e.g., silver) ions. The polymer compositions may have anti-UV properties imparted by metal nanoparticles. Polymer compositions can be made from thermoplastic and thermoset materials.

### CROSS-REFERENCE TO RELATED APPLICATION

This application is a continuation-in-part of U.S. patent application Ser. No. 18/630,239, filed Apr. 9, 2024, which claims the benefit of U.S. Provisional Application No. 63/565,445, filed Mar. 14, 2024, U.S. Provisional Application No. 63/460,813, filed Apr. 20, 2023, and U.S. Provisional Application No. 63/458,391, filed Apr. 10, 2023, which are incorporated by reference in their entirety.

### BACKGROUND

### Technical Field

This disclosure relates to polymer compositions containing antimicrobial nanoparticles, methods of manufacture, devices formed therefrom.

### Related Technology

Polymers used in medical and other applications are typically inexpensive and can be used for many different functions. Polymeric articles of manufacture may be manufactured using injection molding processes. One issue with mold injected polymers is that the surface finish of the product can be sponge-like, with pores that can extend several microns deep into the product. FIG. 1, for example, is a scanning transmission electron microscope (STEM) image of a surface of polystyrene from a thermal extruded pellet. The polymer surface has a high degree of porosity that can harbor bacteria and other microbes. Such microbial growth can be concerning for hospitals and others in the medical field. The management of polymers used in areas of high sensitivity, including many medical applications, may require expensive and rigorous sterilization and storage procedures. Even when following sterilization guidelines, infections can still result from polymer devices used to deliver substances to patients and/or implanted into patients. Drug resistant microbial infections may also result from the use of compromised polymer products, causing expensive healthcare maintenance and even death.

The overuse of antibiotics has contributed, in some cases, to antibiotic resistant bacteria and other treatment resistant microbes. There is concern that an increase in antibiotic resistance may lead to microbes that are untreatable with conventional technologies. In some cases, medical devices that incorporate antibiotics do not reliably prevent formation of biofilms and/or prevent infection from bacteria with antibiotic resistance. In such cases, the use of antibiotics in polymeric materials may not reliably protect the patient from infection.

There are attempts to incorporate ionic colloidal silver and silver nanoparticles into polymeric materials to import antimicrobial activity to polymers. However, antimicrobial resistance has now been discovered for colloidal silver (i.e., silver nanoparticles manufactured by conventional chemical reduction processes, typically with some form of capping agent, which are known to release silver ions) and ionic silver. McNeilly et al., “Emerging Concern for Silver Nanoparticle Resistance in Acinetobacter baumannii and Other Bacteria,” Front. Microbiol., 16 Apr. 2021, discuss the emergence of several antibiotic-resistant bacteria, including Acinetobacter baumannii, Enterococcus faccium, Staphylococcus aureus, Klebsiella pneumoniac, Acinetobacter baumannii, Pseudomonas acruginosa, and Enterobacter spp. Of these, A. baumannii was of particular concern and was found to also have developed resistance to colloidal silver nanoparticles, as were E. Coli, Enterobacter cloacae, S. typhimurium, B. subtilis, S. aureus. P. aeruginosa, K. pneumoniac, Serratia marcescens, Acinetobacter spp.

Silver, “Bacterial silver resistance: molecular biology and uses and misuses of silver compounds,” FEMS Microbiology Reviews, Volume 27, Issue 2-3, June 2003, Pages 341-35, discusses silver-resistant Salmonella, and Escherichia coli. Elkrewi, et al., “Cryptic silver resistance is prevalent and readily activated in certain Gram-negative pathogens,” J. Antimicrob. Chemother., 2017 Nov. 1; 72 (11): 3043-3046 discloses colloidal silver nanoparticle resistance by gram negative pathogens, such as Enterobacter spp., Klebsiella spp. Escherichia coli, Pseudomonas aeruginosa, Acinetobacter spp., Citrobacter spp., and Proteus spp. Hosney, “The increasing threat of silver-resistance in clinical isolates from wounds and burns,” Infect Drug Resist. 2019; 12:1985-2001 discusses colloidal silver-resistant Klebsiella pneumoniae, Staphylococcus aureus, Escherichia coli, Enterobacter cloacac, Pseudomonas aeruginosa, and Acinetobacter baumannii. Percival, et al., “Bacterial resistance to silver in wound care, J. Hospital Infection, Vol. 60, Issue 1, May 2005, pp. 1-7, discusses the fear and possibility of colloidal silver-resistant microbes in wounds. Kędziora, et al., “Consequences Of Long-Term Bacteria's Exposure To Silver Nanoformulations With Different PhysicoChemical Properties,” Intl. J. of Nanomedicine, 2020:15 199-213, discusses colloidal silver-resistant gram positive and gram negative bacteria.

An article entitled “Are Silver Nanoparticles a Silver Bullet Against Microbes?” Jul. 13, 2021, https://news.engineering.pitt.edu/are-silver-nanoparticles-a-silver-bullet-against-microbes/(accessed Oct. 12, 2022), discusses colloidal silver nanoparticle resistant E. coli., stating: “In the beginning, bacteria could only survive at low concentrations of silver nanoparticles, but as the experiment continued, we found that they could survive at higher doses . . . . Interestingly, we found that bacteria developed resistance to the silver nanoparticles but not their released silver ions alone.” The group sequenced the genome of the E. coli that had been exposed to silver nanoparticles and found a mutation in a gene that corresponds to an efflux pump that pushes heavy metal ions out of the cell. “It is possible that some form of silver is getting into the cell, and when it arrives, the cell mutates to quickly pump it out . . . . More work is needed to determine if researchers can perhaps overcome this mechanism of resistance through particle design.”

Silver nanoparticles made by conventional chemical synthesis methods have external bond angles and edges where silver ions can be released, even though the bulk nanoparticles are ground state. Adding metal nanoparticles that release ions into polymers yields nanoparticle-impregnated polymers and plastics that are a source of unwanted metal ions, such as silver ions, which may be toxic to human and animal tissues under excess exposure. Moreover, the release of ions may decrease over time. Even where there are beneficial antimicrobial effects associated with silver ion release, such effects will degrade over time as ions are leached out of the bulk polymer material. Where silver ion release is the major mode of antimicrobial action, which is the case for conventional colloidal silver treated polymer products, the antimicrobial activity of the polymer will likewise degrade over time.

Additionally, exposure to solar radiation can cause weakening and other structural damage to polymers. When absorbed by polymers, UV energy may excite electrons, creating free radicals that can lead to degradation of the plastic. Polymers that have been affected by UV radiation may appear chalky, the surface of the polymer may become brittle, and there may be a noticeable color change on the surface of the polymer. UV-caused degradation may lead to cracks in the polymer product and may cause the product to fail altogether. For example, UV radiation may activate tertiary carbon bonds in the structures of polypropylene and/or low-density polyethylene, which then interact with atmospheric oxygen. This can produce carbonyl groups in the main chain of the structure, leaving the plastic product prone to cracking and/or discoloration.

In view of the foregoing, there remains a need to find improved polymer materials that exhibit effective antimicrobial properties for use in medical devices, including implantable medical devices and/or that resist UV-induced degradation.

### SUMMARY

Disclosed are polymer compositions incorporating metal nanoparticles and medical devices made therefrom. Methods for integrating metal nanoparticles into polymers are also disclosed. The disclosed polymer compositions can be utilized to form medical and other devices, including implantable medical devices, that have effective antimicrobial properties. The disclosed polymer compositions incorporate metal nanoparticles that have anti-microbial activity without the release of metal (e.g., silver) ions. Methods for integrating metal nanoparticles into polymers are also disclosed.

In some embodiments, polymer compositions incorporating metal nanoparticles may also effectively resist UV damage when exposed to sunlight and/or other sources of UV light. For example, the disclosed polymer compositions may include wavelength-shifting metal nanoparticles that function to protect exposed surfaces from UV radiation. For example, the polymer compositions can down-convert incoming UV light to light of longer wavelength that is less damaging, or non-damaging, to polymer linkages.

The disclosed polymer compositions comprising metal nanoparticles advantageously have antimicrobial properties that prevent colonization of microbes thereon, including preventing colonization of microbes within pores of the polymer materials and structures formed therefrom. Such nanoparticle-modified polymers are less prone to develop silver nanoparticle microbial resistance, as can occur with colloidal silver made via chemical synthesis. Surprisingly and unexpectedly, it has been found that nonionic silver nanoparticles formed by laser ablation do not lead to silver nanoparticle microbial resistance, as has been observed with colloidal silver and/or silver nanoparticles made by chemical synthesis, which provide antimicrobial activity through release of silver ions. It is believed that antimicrobial resistance may be the result of bacteria adapting by ejecting silver ions from the cell membrane, such as via ion pumps.

In some embodiments, spherical metal (e.g., silver) nanoparticles can have a mean diameter and a particle size distribution in which at least 99% of the spherical metal nanoparticles have a particle size within 30% of the mean diameter, or within 20% of the mean diameter, or within 10% of the mean diameter and/or wherein at least 99% of the spherical metal nanoparticles have a diameter within +3 nm of the mean diameter, or within +2 nm of the mean diameter, or within +1 nm of the mean diameter.

As used herein, unless indicated otherwise, the mean diameter (i.e., average particle size) refers to the number average, which can be determined according to standard methods known in the art. As an example, the mean diameter may be determined via microscopy (e.g., scanning transmission electron microscope (STEM)) and analysis of resulting images. Another suitable method for determining mean diameter of a set of metal nanoparticles is dynamic light scattering (DLS), which is typically reported on a volume basis.

In some embodiments, the polymer compositions may comprise coral-shaped metal nanoparticles instead of or in addition to spherical metal nanoparticles. Coral-shaped metal (e.g., gold) nanoparticles have a non-uniform cross section and a globular structure formed by multiple, non-linear strands joined together without right angles. In some cases, the coral-shaped metal nanoparticles can be used to potentiate the effect of spherical metal (e.g., silver) nanoparticles.

In some embodiments, metal nanoparticles can comprise at least one metal selected from the group consisting of silver, gold, platinum, palladium, rhodium, osmium, ruthenium, rhenium, molybdenum, copper, iron, nickel, tin, beryllium, cobalt, antimony, chromium, manganese, zirconium, tin, zinc, tungsten, titanium, vanadium, lanthanum, cerium, heterogeneous mixtures thereof, and alloys thereof. Nanoparticles comprised of silver, gold, and mixtures and alloys thereof can be particularly effective.

In some embodiments, the polymer compositions can be made from thermoplastic materials in which metal nanoparticles are incorporated therein, such as by coating polymer granules (used interchangeably herein with “beads” or “pellets”) (e.g., using a volatile solvent, which is removed by evaporation) that are then thermoplastically formed into a desired structure of article of manufacture. In some embodiments, the polymer compositions can be thermoset compositions made from multi-part (e.g., two-part) compositions, where metal nanoparticles are included in one or both parts of the composition, wherein the two-part composition hardens or solidifies by a curing system selected from chemical cure, heat cure, or light (e.g., UV) cure. In each case, the metal nanoparticles become mixed throughout the polymer composition, either when in a molten state prior to molding and cooling or in a liquid state prior to molding and thermosetting.

To manufacture shaped products from thermoplastic polymers, polymer granules used to mold polymeric articles of manufacture can be treated (e.g., coated and/or impregnated) with metal (e.g., silver and/or gold) nanoparticles, such as by dispersing the metal nanoparticles in a volatile solvent (e.g., water and/or organic solvent), applying the nanoparticle dispersion or solution to the polymer granules, optionally allowing the solvent and metal nanoparticles to the polymer granules, and allowing the solvent to evaporate using means known in the art (e.g., through application of heat, moving dry gas, and/or reduced pressure), leaving the metal nanoparticles on and/or impregnated in the polymer granules. When the metal nanoparticle-treated polymer granules are heated into a molten state within a forming apparatus, such as an auger, extruder, or injection molding machine, the metal nanoparticles become distributed throughout the molten thermoplastic polymer and the plastic materials and articles made therefrom.

In the case of multi-part (e.g., two-part) curable resins used to make thermoset polymer products, metal nanoparticles can be included in one or more parts of the system (e.g., in monomer- and/or oligomer-based resins). When the two or more parts are mixed together, the metal nanoparticles are blended throughout the mixture and will solidify in place within the product or article into which the composition is shaped. The multi-part curable resin typically includes an initiator system that causes the resin to cure into a cured polymer. The initiator system can be a chemical cure system, light cure system, and/or heat cure system, and can include initiators known in the art.

In some embodiments, a first type of nanoparticle (e.g., spherical-shaped silver nanoparticles) may be included in a first part of a two-part thermoset polymer system and a second type (e.g., coral-shaped gold nanoparticles) may be included in a second part of the two-part thermoset polymer system.

The portion of metal nanoparticles on the surface of shaped polymer materials or structures and/or embedded within pores in communication with the polymer surface can provide antimicrobial activity to prevent microbial growth on the surface of the polymer material. In addition, metal nanoparticles can be selected to protect polymer materials from damage by UV radiation, such as by down-converting incoming UV radiation to lower energy radiation (e.g., visible light) that is less damaging, or non-damaging, to the polymer material.

The polymer compositions disclosed herein can beneficially provide antimicrobial and UV protective effects for extended durations, without depletion of the nanoparticles, even after abrasion or machining. For example, because the embedded nanoparticles do not rely on ion release as the primary means of antimicrobial activity, the polymer compositions disclosed herein can provide their antimicrobial function longer than polymer compositions incorporating conventional nanoparticles formed via chemical synthesis and that release ions.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1 is a scanning transmission electron microscopy (STEM) image of a surface of polystyrene formed from thermal extruded pellets;

FIGS. 2A-2C are STEM images that illustrate thermoplastics containing silver (Ag) nanoparticles;

FIGS. 3A-B schematically illustrate a microbe after having absorbed spherical-shaped metal nanoparticle from a substrate and disulfide bonds being catalytically denatured by a spherical-shaped nanoparticle;

FIG. 4 illustrates a STEM image of silver (Ag) nanoparticles inside a MRSA SA62 drug resistant bacteria;

FIGS. 5A-5C illustrate STEM images of Tecoflex EG-93A-B20 thermoplastic polymer (a thermoplastic polyurethane, or TPU) embedded with silver nanoparticles;

FIGS. 6A-6C illustrate STEM images of Isoplast 2510 thermoplastic polymer (another TPU) embedded with silver nanoparticles;

FIG. 7A illustrates thermoplastic pellets that have been treated with silver (Ag) nanoparticles;

FIG. 7B illustrates an extruded filament from thermoplastic pellets such as those illustrated in FIG. 7A; and

FIGS. 8A-8B illustrate a close-up STEM image of an embedded spherical-shaped silver (Ag) nanoparticle in a thermoplastic material.

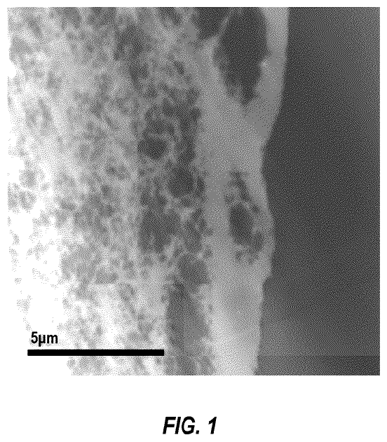

### DETAILED DESCRIPTION

### I. Introduction

The term “nanoparticle” often refers to particles having a largest dimension of less than 100 nm. Bulk materials typically have constant physical properties regardless of size, but at the nanoscale, size-dependent properties often predominate. Thus, properties of materials change as their size approaches the nanoscale and as the percentage of atoms at the surface of a material becomes significant. For bulk materials larger than one micrometer (or micron) in cross section, the percentage of atoms at the surface is insignificant in relation to the number of atoms in the bulk of the material. The interesting and sometimes unexpected properties of nanoparticles are therefore largely due to the large surface area of the material, which dominates the contributions made by the relatively small bulk of the material.

Because it has now been discovered that nonionic metal nanoparticles formed by laser ablation are less likely to result in antimicrobial resistance, which is unexpected given the extensive data for conventional silver nanoparticles made by chemical synthesis, the concentration of silver nanoparticles required to effectively kill microbes remains essentially the same over time. This is in contrast to colloidal silver and other silver nanoparticles made by chemical synthesis, which have external bond angles and typically release silver ions to impart antimicrobial activity. When antimicrobial resistance to colloidal silver and other silver ion-releasing silver nanoparticles or compounds occurs, increasing concentrations of such nanoparticles are necessary to maintain the ability to kill microbes.

The metal nanoparticles used in the disclosed polymer compositions can be nonionic, ground state, and without external edges or bond angles that cause release of metal ions. Spherical-shaped metal nanoparticles are typically used to kill microbes, although coral-shaped metal nanoparticles can provide anti-microbial activity, typically in combination with spherical metal nanoparticles.

The metal nanoparticles incorporated into polymers as disclosed herein comprise or consist essentially of nonionic, ground state metal nanoparticles without external edges or bond angles that cause release of metal ions. Examples include spherical metal nanoparticles, coral-shaped metal nanoparticles, and blends of spherical-shaped and coral-shaped metal nanoparticles.

Conventional silver nanoparticles manufactured via chemical reduction (typically involving a capping agent) tend to exhibit a clustered, crystalline, faceted, or hedron-like shape rather than a true spherical shape with round and smooth surfaces. Such nanoparticles typically form clusters and have a broad size distribution. In some cases, conventional silver nanoparticles are formed as shells of silver formed over a non-metallic seed material.

In contrast, the spherical-shaped nanoparticles that included in polymer compositions disclosed herein can exhibit one or more of: (1) solid metal form, (2) unclustered, (3) exposed/uncoated/uncapped surfaces (i.e., they are pure metal with no organic capping or stabilizing molecules, (4) smooth surface morphology, and (5) narrow particle size distribution. In preferred embodiments, all five of these aspects are present in the metal nanoparticles. As used herein, an “exposed” or “uncoated” surface is one that omits capping or other organic stabilizing agents and instead has a fully exposed metal surface that can interact with the surrounding environment.

The metal nanoparticles of the disclosed polymer compositions, including spherical-shaped and coral-shaped nanoparticles, may comprise any desired metal, mixture of metals, or metal alloy, including at least one of silver, gold, platinum, palladium, rhodium, osmium, ruthenium, rhenium, molybdenum, copper, iron, nickel, tin, beryllium, cobalt, antimony, chromium, manganese, zirconium, tin, zinc, tungsten, titanium, vanadium, lanthanum, cerium, heterogeneous mixtures thereof, or alloys thereof. Nanoparticles comprised of silver, gold, and mixtures and alloys thereof can be particularly effective.

In some embodiments, gold (Au) nanoparticles are included in the polymer compositions and can function to down-shift incoming UV radiation to less energetic wavelengths. The gold nanoparticles may down-convert the higher energy wavelengths into lower energy and less harmful light of longer wavelength(s). The gold nanoparticles may down-convert UV or other higher energy wavelengths to the red and/or infrared region of the light spectrum. In some embodiments, gold nanoparticles are spherical-shaped. In some embodiments, gold nanoparticles have a particle size in a range of about 1 nm to about 40 nm in diameter.

In some embodiments, silver (Ag) nanoparticles are included in the polymer compositions to impart or enhance antimicrobial properties to the polymer compositions. In some embodiments, silver nanoparticles are spherical. In some embodiments, silver nanoparticles have a particle size in a range of about 1 nm to about 10 nm in diameter.

Examples of metal (e.g., silver and gold) nanoparticles and nanoparticle compositions that can be used herein are disclosed in: U.S. Pat. Nos. 9,849,512; 9,434,006; 9,919,363; 10,137,503; and 10,610,934, which are incorporated herein by reference.

### II. Nanoparticles

Metal nanoparticles used in the disclosed polymer compositions can include nonionic, ground state metal nanoparticles without external edges or bond angles, which can cause the undesirable release of metal ions. Metal nanoparticle may include spherical metal nanoparticles, coral-shaped metal nanoparticles, or a combination thereof. Spherical metal nanoparticles typically have greater antimicrobial activity, although coral-shaped metal nanoparticles can also provide anti-microbial activity and can potentiate the antimicrobial activity of spherical-shaped metal nanoparticles when the two are combined.

Nonionic, ground state, spherical-shaped metal nanoparticles with no external edges or bond angles, and compositions containing such nanoparticles, can be made according to the disclosure of U.S. Pat. Nos. 9,849,512, 10,137,503, and 10,610,934. Nonionic, ground state, coral-shaped metal nanoparticles with no external edges or bond angles, and compositions containing such nanoparticles, can be made according to the disclosure of U.S. Pat. No. 9,919,363. Compositions that contain a mixture of spherical metal nanoparticles and coral-shaped metal nanoparticles are disclosed in U.S. Pat. No. 9,434,006. The foregoing patents are incorporated herein by reference in their entirety.

In some embodiments, liquid media applied to polymer compositions (such as to polymer granules) may include nanoparticles at a concentration of about 50 ppb to about 100 ppm, or about 100 ppb to about 50 ppm, or about 200 ppb to about 20 ppm, or about 400 ppb to about 10 ppm, or about 600 ppb to about 6 ppm, or about 800 ppb to about 4 ppm, or about 1 ppm to 3 ppm, or about 2 ppm by weight of the liquid medium applied to the polymer composition.

After the metal nanoparticles have been incorporated into the polymer composition, the nanoparticles may have a concentration in a range of about 0.5 mg/kg to about 8 mg/kg, such as about 1 mg/kg, 2 mg/kg, 3 mg/kg, 4 mg/kg, 5 mg/kg, 6 mg/kg, 7 mg/kg, or a range with any combination of the foregoing values as endpoints.

In some embodiments, spherical metal nanoparticles can have an average particle size (i.e., diameter) in a range of about 1 nm to about 20 nm, such as about 3 nm to about 14 nm, or about 4 nm to about 13 nm, or about 5 nm to about 12 nm, or about 6 nm to about 10 nm. In some embodiments, spherical metal nanoparticles can have a diameter of about 40 nm or less, about 35 nm or less, about 30 nm or less, about 25 nm or less, about 20 nm or less, about 15 nm or less, about 10 nm or less, about 7.5 nm or less, or about 5 nm or less. The compositions may include nanoparticles in a concentration range with endpoints defined by any two of the foregoing values.

The spherical metal nanoparticles can have a particle size distribution wherein at least 99% of the metal nanoparticles have diameters within 30% of the mean diameter, or within 20% of the mean diameter, or within 10% of the mean diameter and/or wherein at least 99% of the spherical-shaped nanoparticles have diameters within +3 nm of the mean diameter, or within +2 nm of the mean diameter, or within +1 nm of the mean diameter. Because of their nonionic nature and narrow particle size distribution, the spherical nanoparticles can have a g-potential of at least about +10 mV (absolute value), or at least about +15 mV, or at least about +20 mV, or at least about +25 mV, or at least about +30 mV. Such g-potentials can help the metal nanoparticles remain dispersed in polar solvents without a dispersing agent.

In some embodiments, coral-shaped metal nanoparticles can be used instead of or in combination with spherical metal nanoparticles. In general, spherical metal nanoparticles can be smaller than coral-shaped metal nanoparticles and, in this way, can provide very high surface area for catalyzing desired reactions or providing other desired benefits. On the other hand, the generally larger coral-shaped nanoparticles can exhibit higher surface area per unit mass compared to spherical nanoparticles because coral-shaped nanoparticles have internal spaces and surfaces rather than solid cores and only an external surface.

In at least some cases, providing nanoparticle compositions containing both spherical-shaped and coral-shaped nanoparticles can provide synergistic results. Coral-shaped nanoparticles can help carry and/or potentiate the activity of spherical-shaped metal nanoparticles in addition to providing their own unique benefits. For example, smaller (e.g., spherical-shaped) metal nanoparticles may offer better protection against UVB radiation, while relatively larger (e.g., coral-shaped) metal nanoparticles may offer better protection against UVA radiation. In some embodiments, a combination of spherical-shaped and coral-shaped metal nanoparticles can lead to synergistic, broad-spectrum protection with a greater amount of protection (e.g., amount of UV radiation reflected) per amount of active ingredient relative to single sized and/or shaped metal nanoparticles.

In embodiments where both spherical and coral-shaped metal nanoparticles are included in a polymer composition, the mass ratio of spherical nanoparticles to coral-shaped nanoparticles in the nanoparticle composition can be in a range of about 1:1 to about 50:1, or about 2.5:1 to about 25:1, or about 5:1 to about 20:1, or about 7.5:1 to about 15:1, or about 9:1 to about 11:1, or about 10:1. The particle number ratio of spherical nanoparticles to coral-shaped nanoparticles in the nanoparticle composition can be in a range of about 10:1 to about 500:1, or about 25:1 to about 250:1, or about 50:1 to about 200:1, or about 75:1 to about 150:1, or about 90:1 to about 110:1, or about 100:1.

In some embodiments, at least a portion of the metal nanoparticles are selected to selectively reflect, block, and/or scatter a particular range of solar radiation. For example, a first set of metal nanoparticles may be selected as spherical-shaped metal nanoparticles having a smaller relative size and which therefore selectively reflect, scatter, and/or block more particularly UVB radiation, while a second set of metal nanoparticles may be selected as coral-shaped metal nanoparticles having a larger relative size and which therefore selectively reflect, scatter, and/or block more particularly UVA radiation.

In some embodiments, the polymer compositions include at least one spherical-shaped anti-microbial metal nanoparticle component and larger coral-shaped nanoparticle component.

In some embodiments, compositions containing metal nanoparticles may be utilized in plastic manufacturing processes to produce plastic products with embedded nanoparticles.

### III. Antimicrobial Function of Nanoparticles

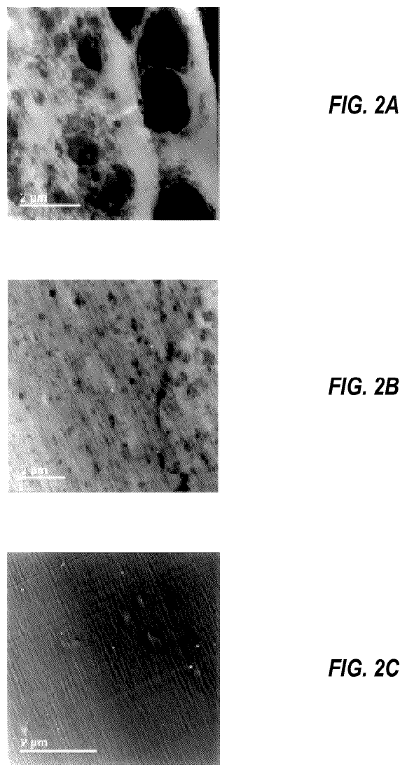

FIGS. 2A-2C are STEM images that illustrate thermoplastics containing silver (Ag) nanoparticles, which provides the polymer composition with antimicrobial and/or wavelength shifting properties.

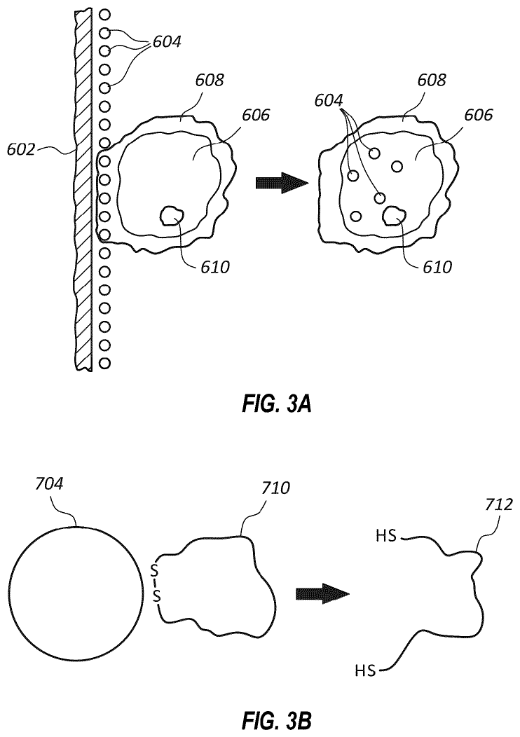

FIGS. 3A-3B schematically illustrate a microbe after having absorbed a spherical-shaped metal nanoparticle from a substrate and disulfide bonds being catalytically denatured by the spherical-shaped nanoparticle. FIG. 3A schematically illustrates a microbe 608 having absorbed spherical-shaped nanoparticles 604 from a solid substrate 602, such as by active absorption or other transport mechanism. The nanoparticles 604 can freely move throughout the interior 606 of microbe 608 and come into contact with one or more vital proteins or enzymes 610 that, when denatured, kill or disable the microbe.

One way that metal nanoparticles may kill or denature a microbe is by catalyzing the cleavage of disulfide (S—S) bonds within a vital protein or enzyme. FIG. 3B schematically illustrates a microbe protein or enzyme 710 with disulfide bonds being catalytically denatured by an adjacent spherical-shaped nanoparticle 704 to yield denatured protein or enzyme 712. In the case of bacteria or fungi, the cleavage of disulfide bonds and/or cleavage of other chemical bonds of vital proteins or enzymes may occur within the cell interior to thereby kill the microbe in this manner. Such catalytic cleavage of disulfide (S—S) bonds is facilitated by the generally simple protein structures of microbes, in which many vital disulfide bonds are exposed and readily cleaved by catalysis.

Another potential mechanism by which metal (e.g., silver) nanoparticles may kill microbes is through the production of active oxygen species, such as peroxides, which can oxidatively cleave protein bonds, including but not limited to amide bonds.

Notwithstanding the lethal nature of nonionic metal nanoparticles relative to microbes, they have been shown to be harmless and non-toxic to humans, mammals, and other animals, which have much more complex protein structures compared to simple microbes. In such higher life form, most or all vital disulfide bonds are shielded by other, more stable regions of the protein. In many cases the nonionic nanoparticles do not interact with or attach to human cells, other mammalian cells, or other animal cells, and can be quickly and safely expelled through the urine without damaging kidneys or other cells, tissues, or organs. Also, the nonionic silver nanoparticles do not release silver ions, meaning their effects cease when excreted.

In the case of spherical silver (Ag) nanoparticles, the interaction of the silver (Ag) nanoparticle(s) within a microbe has been demonstrated to be particularly lethal without the need to rely on the production of silver ions (Ag⁺) to provide the desired antimicrobial effects, as is typically the case with conventional colloidal silver compositions. The ability of silver (Ag) nanoparticles to provide effective antimicrobial activity without significant or actual release of toxic silver ions (Ag⁺) into the patient or surrounding environment is a substantial advancement in the art. Whatever amount or concentration of silver ions released by silver nanoparticles, if any, is typically unmeasurable and well below known or inherent toxicity levels for animals, such as mammals, birds, reptiles, fish, and amphibians.

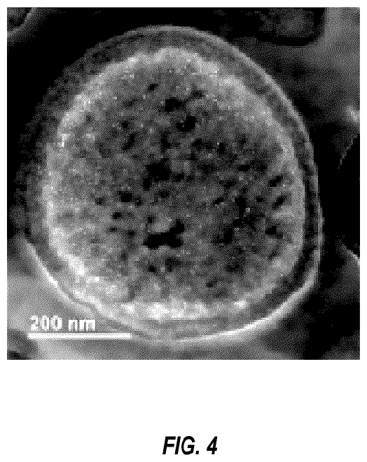

FIG. 4 illustrates a STEM image of silver (Ag) nanoparticles inside a MRSA SA62 drug resistant bacterium. The STEM image in coordination with Electron Diffraction Spectroscopy provided confirmation of disruption at sites of disulfide bonds and ferredoxins.

The use of nonionic silver nanoparticles made using laser ablation provides advantages over conventional silver nanoparticles, which are known to primarily function via release of silver ions and which have been shown to lead to antimicrobial silver nanoparticle resistance. As discussed above, conventional silver nanoparticles made using chemical reduction processes are known to lead to antimicrobial resistance, meaning their effective in killing microbes diminishes over time. Some studies have shown microbial resistance to ionic silver in as few as 6 generations.

In contrast, spherical-shaped nanoparticles included in polymer compositions disclosed herein have been shown to have stable antimicrobial activity even after 28 passages, with no diminution of antimicrobial activity, including no significant reduction in the MIC (minimum inhibitory concentration).

### IV. UV Protective Function of Nanoparticles

Metal nanomaterials of the type disclosed herein and having diameters or sizes in the range of about 10 nm to 40 nm can have loose dielectric fields. When a large quantity of nanoparticles are together, the dielectric effect on light waves passing through does not attenuate but can be frequency-shifted either to the red or to the blue end of the electromagnetic spectrum. Polymer compositions that have enough of such nanoparticles can affect impinging UV radiation and shift it to the red end of the spectrum to reduce entry of photonic energy at levels that reduce or eliminate damage.

In some embodiments, the polymer compositions can include metal nanoparticles having a high refractive index in order to reflect and/or scatter incident UV radiation. For example, metal nanoparticles used in polymer compositions of the present disclosure can have a refractive index for UVA and/or UVB radiation of about 1.5 to about 4.6, or from about 2.0 to about 4.0, or from about 2.5 to about 3.5. In some embodiments, the refractive index of the nanoparticles can be higher with respect to UVB radiation than to UVA radiation (e.g., the refractive index increases with decreasing wavelength). In other embodiments, the refractive index of the metal nanoparticles can be lower with respect to UVB radiation relative to UVA radiation (e.g., the refractive index increases with increasing wavelength).

In some embodiments, the polymer compositions can include metal nanoparticles having a photostability such that upon exposure to solar radiation (e.g., in an environment with a relatively high UV index of about 15), the metal nanoparticles do not degrade or lose effectiveness in protecting against UV radiation (e.g., remain about 100% effective, or about 95-100% effective, or about 90-100% effective, or about 80-100% effective) over a given time period (e.g., about 1 hour, or about 2-4 hours, or about 4-6 hours, about 6-12 hours or longer, or even indefinitely).

In some embodiments, metal nanoparticle can impart radiation protection properties to polymer compositions. For example, some embodiments may include a plurality of metal nanoparticles (e.g., beryllium and/or gold) configured to absorb harmful radiation (e.g., alpha particles, beta particles, and/or gamma radiation), thereby reducing or eliminating harmful radiation passing through the nanoparticle treated polymer.

In some embodiments, gold nanoparticles dispersed throughout a polymer composition down-convert incoming UV radiation into less harmful UV radiation. In some embodiments, gold nanoparticles may down-shift incoming UV radiation by at least about 50 nm, or at least about 100 nm, or at least about 150 nm, such as by approximately 200 nm. In some embodiments, gold nanoparticles may down-shift incoming UV radiation from UV light to visible light. In some embodiments, gold nanoparticles may down-shift incoming UV radiation from UV wavelengths toward red and/or green wavelengths.

In some embodiments, gold nanoparticles dispersed throughout a polymer may absorb incoming UV radiation down-convert it to lower energy wavelengths, thereby imparting UV protection to the polymer composition and products made therefrom. Unexpectedly, the ability of the gold nanoparticles to perpetually down-convert high energy radiation does not deteriorate with use. That is, gold nanoparticles have been shown to retain their UV protection capabilities and were not measurably degraded by incoming UV radiation. This beneficially prolongs the effectiveness of polymer compositions and products made therefrom. This also means that a lower concentrations of gold nanoparticles or other wavelength-shifting metal nanoparticles can be used, resulting in products that are cheaper to make while maintaining integrity.

### V. Overview of Plastics Manufacturing

Some common plastics manufacturing processes are extrusion and injection molding. Many medical products are manufactured using one of the two processes.

In the extrusion process, polymeric pellets or granules are fed into an extrusion machine by a hopper. The polymeric pellets or granules are heated and melted inside a barrel, sometimes with the aid of an auger. The melted polymer is then extruded through a metal die by a screw auger, creating a fixed, continuous shape. The resulting extruded polymer object can be cut or trimmed as desired. The extrusion process is commonly used for manufacturing pipes, tubes, frames, symmetrical devices, pellets, etcetera.

Injection molding involves injecting a molten thermoplastic polymer into a pre-existing mold. The molten thermoplastic polymer can be formed by heating polymeric pellets or granules. Once injected into the mold, the polymer can cool and solidify into its final shape. The molten polymer is generated similarly to the extrusion process-polymer pellets or granules are fed into a barrel or other chamber by a hopper where they are heated and melted. A combination extrusion-injection molding process may be used when a hollow product is desired.

Additives may be included in the plastic pellets or granules, which are melted and shaped to create final products. Colorants, stiffeners, and other enhancers may be sprayed or coated onto the pellets prior to heating. For example, colorants can be dissolved or dispersed in a volatile solvent and sprayed onto polymer pellets. Upon heating, the volatile solvent will evaporate off, leaving the colorant evenly distributed among the pellets. Upon heating the treated polymer pellets, the colorant can be evenly dispersed in the melted polymer and result in uniformly colored products. Other additives may similarly be incorporated into the plastic products.

Thermoset polymers are also useful materials that can be molded or shaped into a desired object. Rather than being heated to above a melting point, thermoset polymers are typically formed by mixing two or more initial separate components that formulated react together to form an initial mixture that is flowable. The flowable mixture can be molded into a desired shape in similar fashion as thermoplastic materials. The components in the thermoset composition react together to cause polymerization and/or cross-linking to form a solidified thermoset polymer. Initiators for thermoset composition can be chemical cure, heat cure, and/or light cure, systems known in the art.

Examples of materials for manufacturing medical devices and other polymer objects or configurations include silicone, polysiloxanes, epoxies, polystyrene (PS), polyethylene (PE) (including low density polyethylene (LDPE), linear low density polyethylene (LLDPE), and high density polyethylene (HDPE)), polypropylene (PP), ethylene-vinyl acetate copolymer (EVA), polycarbonate (PC), polyurethane (PU), polyether ether ketone (PEEK), polylactic acid (PLA), polyhydroxyalkanoate (PHA), polyester (PES), polyethylene terephthalate (PET), polymethyl methacrylate (PMMA), polybutylene terephthalate (PBT), phenol-formaldehyde (PF), nylon/polyimide (PA), melamine formaldehyde (MF), polytetrafluoroethylene (PTFE), polyvinyl chloride (PVC), polyvinyl pyrrolidone (PVP), acrylonitrile butadiene styrene terpolymers (ABS), styrene block copolymers (SBC), rubber latex (natural or synthetic), nitriles such as nitrile-butadiene rubber (NBR), medical grade thermoplastic elastomer (TPE), aramid fibers such as Kevlar, carbon fiber reinforced polymers, and combinations thereof. Thermoplastics, such as PE and PVC, may be melted and heated multiple times during plastics manufacturing. Thermoset plastics, such as PU and many silicones, remain solid after a curing process has set the plastic. TPUs are thermoset polyurethane polymers that nonetheless retain thermoplastic properties and can be used as such. Some silicones can be thermoplastic.

### VI. Incorporating Nanoparticles Into Polymer Compositions, Resins, Prepolymers, and Monomers

a. Application of Solvent to Polymer Granules

The nonionic metal nanoparticles formed by laser ablation can be manufactured in or subsequently dispersed in liquids (e.g., water and/or organic solvent) that are then applied to polymer pellets/granules/beads. For example, metal nanoparticles may be formed and/or dispersed in water and/or an organic solvent, such as ethanol, isopropyl alcohol, or acetone, and applied to polymer granules, which are subjected to known processes to remove at least a portion of the volatile solvent by evaporation prior to an extrusion or injection molding process. Example methods for removing the volatile solvent include heat evaporation, roto-evaporation, or nitrogen blowdown.

Water and organic solvents can form azeotropes that have a lower boiling point than water and/or the organic solvent to facilitate their removal by evaporation. Although water can be utilized in the nanoparticle solution, many polymer granules are somewhat hygroscopic and readily absorb water, which may be undesirable. In such cases, the nanoparticle-containing liquid may omit water but be applied using an organic solvent.

The nanoparticle solution can be applied to the granules in any suitable manner, such as by spray application or by adding both the liquid and the polymer granules to the same container. In embodiments in which the nanoparticle solution is sprayed onto polymer granules, the granules may be placed on a conveyor system on which they are sprayed. Spray application may be carried out using a cyclonic chamber, optionally with thermal enhancements to aid in driving off the liquid solvent by evaporation.

Following application, the solvent of the nanoparticle solution may be removed by evaporation from the granules, thereby leaving the nanoparticles deposited on and/or impregnated in the polymer granules. This may be accelerated via the application of heat (e.g., infrared, microwave, thermal convention using an inert gas (e.g., nitrogen or argon), or thermal conduction) and/or vacuum or other reduced pressure system. This is preferably performed in an inert gas if solvent is flammable and/or if oxygen or other gas would damage the polymer at higher temperature.

In some embodiments, thermoplastic polymer pellets are coated with metal nanoparticles, placed into an open-ended container, which is filled with a metal nanoparticle solution, and then subjected to an evaporation process. Example solvents include, but are not limited to, 18 megaohm (MO) water, alcohol (e.g., isopropyl alcohol), and a mixture of 18 MO water and alcohol. The combined material (polymer pellets and metal nanoparticle solutions) in the open-ended container is placed inside a vacuum oven to remove the solvent by evaporation and leave behind metal nanoparticles on the surface of the polymer pellets. This application process can be repeated, if necessary, to achieve a desired concentration of metal nanoparticles, as determined by ppm.

In some embodiments, thermoplastic polymer pellets are placed into a roto-evaporator bulb filled with a metal nanoparticle solution. Example solvents include, but are not limited to, 18 megaohm (MO) water, alcohol (e.g., isopropyl alcohol), and a mixture of 18 MO water and alcohol. The combined material (polymer pellets and metal nanoparticle solutions) is subjected to heat and/or reduced pressure inside the roto-evaporator bulb until the water and/or alcohol has been removed by evaporation, leaving behind polymer pellets coated with metal nanoparticles. This application process can be repeated, if necessary, to achieve a desired concentration of metal nanoparticles, as determined by ppm.

In some embodiments, thermoplastic polymer pellets are placed into an open-ended container and filled with a metal nanoparticles solution. Example solvents include, but are not limited to, 18 megaohm (MO) water, alcohol (e.g., isopropyl alcohol), and a mixture of 18 MO water and alcohol. The combined material (polymer pellets and metal nanoparticle solutions) in the open-ended container is placed inside a nitrogen blowdown chamber to remove the solvent by evaporation and leave behind metal nanoparticles on the surface of the polymer pellets. This application process can be repeated, if necessary, to achieve a desired concentration of metal nanoparticles, as determined by ppm.

The resulting treated polymer pellets or granules can be heated to form molten polymer comprising a substantially uniform dispersion of metal nanoparticles. The molten polymer may be formed into a desired shape using extrusion, injection molding, or other plastics manufacturing processes to generate polymer products. The end polymer-based product will contain a dispersion of nanoparticles throughout the associated polymer portions of the product. For example, tubing made from the molten polymer may contain a uniform distribution of nanoparticles, thereby enabling antimicrobial and/or UV protective effects throughout the bulk of the polymer.

Centrifuge systems, including batch mode and flow centrifuge systems, may be utilized to associate metal nanoparticles with polymer granules. At sufficient speed (e.g., 10,000 rpm), the centrifuge can force metal nanoparticles to the location of the polymer granules. The higher concentrations at regions of the centrifuge enable increased uptake of metal nanoparticles by the polymer granules, providing absorption of nanoparticles in addition to surface adsorption. This can be beneficial in applications where including metal nanoparticles in sub-surface layers of the resulting polymer material is desired.

b. Application of Solvent to Liquid Polymer Compositions

Metal nanoparticles can additionally or alternatively be incorporated into polymer compositions by directly mixing a solvent that includes the metal nanoparticles with a liquid polymer composition (e.g., a latex emulsion or other emulsion, a polymer suspension, a resin, or a prepolymer) that has not fully cured or otherwise been formed into a solid product, so long as the solvent is not significantly destructive to the components of the liquid polymer composition (e.g., the monomer/oligomer materials) and so long as the solvent is significantly more volatile than the liquid polymer composition. After mixing, the solvent can be removed by evaporation, leaving the liquid polymer inclusive of the metal nanoparticles.

c. Application to Precursor Component

Metal Nanoparticles can additionally or alternatively be incorporated into polymer compositions by mixing the nanoparticles with a precursor polymer component such as polyethylene glycol (PEG) that is added to a liquid polymer composition to be further processed/formed. One or more of such precursor components may include metal nanoparticles, so long as they are used in volumes sufficient to add a desired amount or concentration of metal nanoparticles and are capable of functioning as carriers for the metal nanoparticles prior to mixing with the remaining polymer composition components.

d. Multi-Part Resins

In the case of multi-part (e.g., two-part) curable resins used to make thermoset polymer products, metal nanoparticles can be included in one or both parts of the system. When the two parts are mixed together, the metal nanoparticles are blended throughout the mixture and will solidify in place within the product or article into which the composition is shaped. The multi-part curable resin typically includes an initiator system that causes the resin to cure into a cured polymer. The initiator system can be a chemical cure system, light cure system, and/or heat cure system, and can include components known in the art.

Light curing systems can include a photoinitiator that initiates polymerization and/or cross-linking when exposed to light, such as ultraviolet (UV) light. In some cases, a photoinitiator is needed for focusing enough energy in a concentrated area to start polymerization/crystallization of oligomers/polymers resins. Below are examples of suitable photoinitiators for use with metal (e.g., silver) nanoparticles with compatibility and some enhanced capability. As spherical silver nanoparticles disclosed herein can have a plasmon absorbance/resonance at 405 nm UV light, which these photoinitiators respond to, faster polymerization and strength improvements have been observed.

Following is the list of photoinitiators for resins/coatings containing metal nanoparticles: azobisisobutyronitrile (AIBN), benzoyl peroxide, benzophenone (BP), bisacylphosphine oxide (BPO), camphorquinone, 2,2-Dimethoxoy-2-phenylactonphenone, and 2,4,6-trimethylbenzoldiphenylphosphine oxide (TPO). There are multiple commercial photoinitiators that use the TPO core to produce different radical ratios and require multiple photons to react.

In some embodiments, a first type of nanoparticle (e.g., spherical-shaped silver nanoparticles) may be included in a first part of a two-part thermoset polymer system and a second type (e.g., coral-shaped gold nanoparticles) may be included in a second part of the two-part system.

For example, metal nanoparticles can be dispersed into or mixed with monomers and oligomers used to make polymers, including monomers and oligomers used to make thermoplastic and thermoset polymers. Examples of monomers that can be blended with metal nanoparticles prior to being used to form polymers include, but are not limited to, diols (ethylene glycol, propylene glycol, 1,3-butanediol, 1,4-butanediol (BDO), 1,5-pentanediol, 1,6-hexanediol, polyether glycols, other glycols and diols, e.g., up to 20 carbons or more in length), triols, other polyols (e.g., polyether polyols and polyester polyols), for reaction with isocyanates to make polyurethanes or diacids to make polyesters, isocyanates (e.g., methylene diphenyl diisocyanate (MDI), toluene diisocyanate (TDI), hexamethylene diisocyanate (HDI), isophorone diisocyanate (IPDI), 1,6-hexamethylene diisocyanate (HDI) used to make polyurethanes), dicarboxylic acids to make polyesters or polyamides (e.g., terephthalic acid; adipic acid, and the like), diamines (e.g., to make polyamides), alkenes (e.g., to make polyolefins) and derivatives (e.g., fluorinated alkenes for Teflon, vinyl chloride for polyvinyl chloride, styrene for polystyrene), dienes (e.g., butadiene, isoprene), epoxides (e.g., to make epoxies), bisphenol A (BPA) (e.g., to make polycarbonates), acrylates, methacrylates, acrylonitriles, silanes (e.g., to make polysiloxanes), ketones (e.g., to make polyetheretherketones), phosphazene (e.g., to make polyphosphazenes), chain extenders (e.g. 1,4 butanediol, 1,6 hexanediol, aliphatic diamines (e.g., ethylenediamine (EDA)), aromatic diamines (e.g., 1,4 diaminobenzene, p-phenylenediamine), and cross-linkers.

Other monomers into which metal nanoparticles can be incorporated are listed in “Monomer Product Guide” published by Polysciences, Inc. (which is available at https;//www.polysciences.com and incorporated by reference). Still other monomers into which metal nanoparticles can be incorporated are listed in “Monomers” published by TCI America (which is available at https;//www.tcichemicals.com and incorporated by reference).

Metal nanoparticles can also be mixed with catalysts (e.g., dibutyltin dilaurate), stabilizers, antioxidants, UV stabilizers, and biocompatible additives used in making polymers.

### VII. Medical Devices

Polymer-based products manufactured using one or more of the methods disclosed herein can include medical devices. Medical devices formed in this manner are beneficially protected from microbial growth. Metal nanoparticles incorporated into the medical device are capable of deactivating or killing microbes, preventing microbial build up on or inside the medical devices. This beneficially prolongs the use of the devices in environments such as hospitals or clinics. This also benefits sterilization of the products, leading to lower costs in storage and sterilization procedures.

In some embodiments, metal nanoparticles incorporated into the medical device may also be capable of down-converting incoming UV radiation to lower energy radiation. This beneficially prevents general degradation of the polymer-based device or article from UV radiation. The polymer-based devices or articles will be able to be used for longer periods of time without cracking, discoloration, fogging, leakage, and/or failing completely.

Examples of medical devices that may be formed, at least in part, using the methods disclosed herein include, but are not limited to, gloves (e.g., latex gloves), catheters, wound dressings, syringes and other drug delivery components, silicone products (e.g., breast implants), adhesives, tapes, and polymeric portions of implantable devices (e.g., polymeric portions of pacemakers, replacement joints, drug pumps, intrauterine devices (IUDs), cochlear implants, vascular access devices, artificial heart valves).

### VIII. Examples

### Example 1

Silver nanoparticles were suspended in 99.9% isopropyl alcohol. Inductive Coupled Plasma Optical Emission Spectrophotometry (ICPOES) was used to verify nanoparticle concentration. DLS was used to verify nanoparticle size, which was found to be approximately 6 to 10 nm. STEM imaging with Electron Loss Spectroscopy (ELS) verified surface composition and short bond lengths.

Drug resistant bacteria were found to be killed in concentration ranges of 0.5 mg/L (0.5 ppm) to 2 mg/L (2 ppm) of nanoparticles. The highest concentration found to kill drug resistant bacteria was 8 mg/L (8 ppm). STEM imaging using no stain and a dark field camera with 3 nm of carbon coating allowed for tracking of the nanoparticles within and around a bacterium. The STEM imaging in conjunction with Electron Diffraction Spectroscopy (EDS) provided confirmation of disruption at sites of disulfide bonds and ferredoxins.

### Example 2

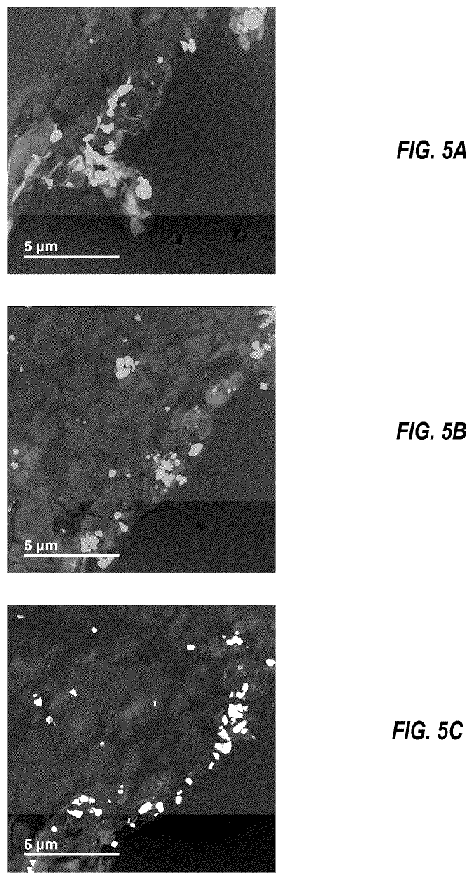

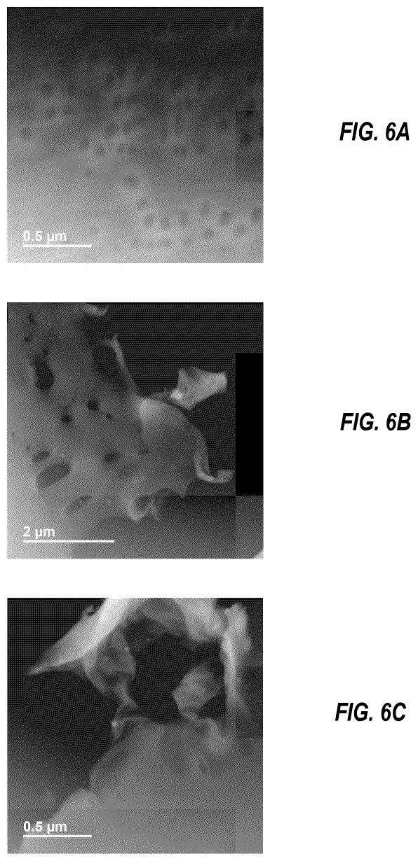

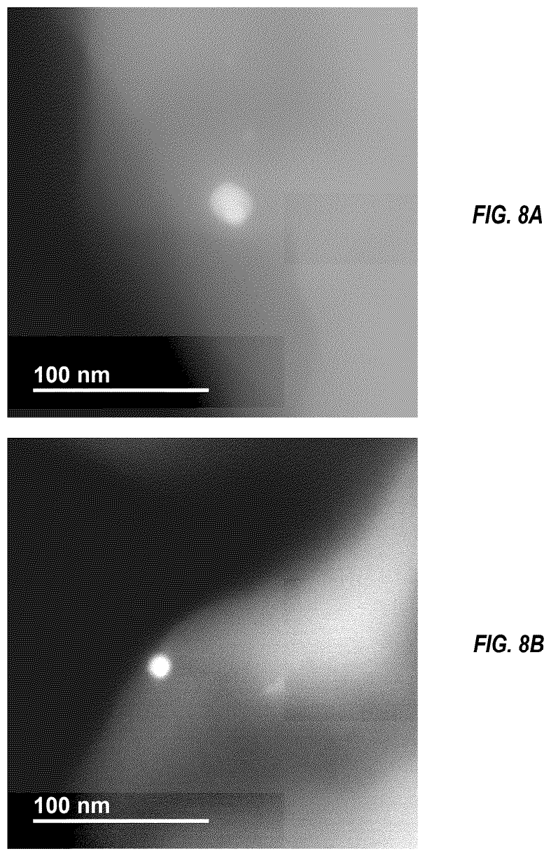

Polyethylene (PE) products embedded with silver nanoparticles were tested for antibacterial properties. Two polymers, Tecoflex FG-93A-B20 (W filament) and Isoplast 2510 (D filament), were provided and each were treated with silver nanoparticles. FIGS. 5A-C illustrate STEM images of Tecoflex EG-93A-B20 thermoplastic with embedded nanoparticles. FIGS. 6A-6C illustrate STEM images of Isoplast 2510 thermoplastic with embedded nanoparticles. FIGS. 8A-B illustrate a silver nanoparticle embedded in a thermoplastic.

The silver nanoparticles were manufactured in isopropyl alcohol at a concentration of 38 mg/L (38 ppm). The isopropyl alcohol mixture was applied to polymer beads or granules. The polymer beads or granules were melted for a final concentration of 6 mg/kg (6 ppm) in the resulting PE polymer. This concentration of 6 mg/kg had previously been successful in surface antibacterial testing.

The isopropyl alcohol was removed using a nitrogen blowdown system, leaving the nanoparticles distributed on the surface of the plastic beads. The polymer beads were then passed through an extrusion melt system at 230° C. to form filaments. The nanoparticles on the surface of the polymer beads intermixed into the filaments produced. The filaments were then embedded in toming polymer and tomed to an 80-100 nm thickness and mounted on 200 mesh formvar Carbon B TEM grids for imaging.

Imaging was performed on a JEOL 2800 Scanning Transmission Electron Microscope (STEM) with a darkfield camera, brightfield camera and a secondary surface camera. Element mapping to 1 nm² resolution was performed to identify nanoparticles and particulates, using a dual EDS detector for triangulation and net count accuracy.

The Tecoflex FG-93A-B20 thermoplastic was light purple in color and required a quenching or cooling stage after melt extrusion at 230° C. As shown in FIGS. 5A-C, under STEM, large solid metal particles hundreds of nanometers in size were observed. EDS mapping confirmed these to be barium sulfate.

Silver nanoparticles directly interact with sulfur chemistry and the overwhelming amount of barium sulfate (which is used as a filler and stiffener in Tecoflex FG-93A-B20) appears to have sequestered the silver nanoparticles. No direct nanoparticles were found on any grid from STEM imaging. Background silver was detected in the barium sulfate particles. Thermal disassociation was seen on the surface of the filaments, which was expected due to lack of thermal control in the final filament formation.

The Isoplast 2510 thermoplastic was darker purple in color and more glass like in surface finish. The Isoplast 2510 thermoplastic was melted at 230° C. and cooled at room temperature (22.5° C.). This thermoplastic used a phosphate as a filler and stiffener instead of barium sulfate. As shown in FIGS. 6A-C, the phosphates did not interact with the Ag nanoparticles, and it was easy to find and element map the silver nanoparticles present. Isoplast 2510 is a more suitable candidate to create an equal distribution of the silver nanoparticles within the plastic. The surface did not have the same type of thermal disassociation.

### Example 3

Surface antibacterial testing was conducted using the standard peni-cylinder method. The conventional peni-cylinder has an outside diameter of 7.8 mm, an inside diameter of 5.8 mm, and is 9.9 mm in length. The surface area can be calculated as:

$${A}_{s} = ( Outside surface area ) + ( inside surface area ) + 2 ( end surface area )$$

$${A}_{s} = 2 42.6 {mm}^{2} + 1 80.4 {mm}^{2} + 42 {mm}^{2}$$

$${A}_{s} = 465 {mm}^{2}$$

Because the ends of the peni-cylinder have a 45° taper, the overall surface area is a little less than calculated but the difference is inconsequential.

20 mm long filament analogs to the peni-cylinder were used for antibacterial testing. The filament diameter was 1.2 mm and for every 1 mm in length there is 7.5 mm² of outside surface area and an ends surface area of 2.3 mm². A 20 mm long filament has a total surface area of A_{f}=152.3 mm². The total number of filaments at 20 mm long needed to represent a peni-cylinder are:

Aₛ/A_{f}=465/152.3=3.1

Three filaments were used in each testing sample set to approximately equal the surface area of one peni-cylinder surface. Metal nanoparticles were suspended throughout each filament.

The filaments were cleaved with a straight edge disposable razor cleaned with 70% or higher isopropyl alcohol. The filaments were measured against a serial surface that has two marks 20 mm apart and the filaments were cleaved to that length. The cut filaments were transferred to a 50 mL sample tube containing 25 mL of isopropyl alcohol and vortexed for 1 minute. The filaments were then removed, using tweezers that had been flame/heat sterilized, to a 50 mL sample holding container.

The antibacterial testing was performed using E. coli at levels of 10⁵, 10⁶ and 10⁷ colony forming units (CFU). Each set of three filaments were introduced to the E. coli in tryptic soy broth for 1 hour of E. coli exposure. Two sample sets (of three filaments) were used for each concentration of E. coli.

The filaments were removed from the tryptic soy broth containing the E. coli colonies and allowed to drip until the filaments were free of fluids. The filaments were then introduced to dey-engley (DE) broth with a purple color. If any E. coli bacteria grew from the filaments transferred to the DE broth, the color of the broth would turn yellow.

Samples of the DE broth were cultured for any colony growth on tryptic soy agar plates and compared with the cultures of the originally prepared 10⁵, 10⁶ and 10⁷ CFUs. Colony counts were then made after 24 and 48 hours of growth. CFUs of the E. coli were verified by agar counts: 10⁵=23 CFUs; 10⁶=256 CFUs; and 10⁷=1000 CFUs.

After 24 hours of testing there were 0 CFUs on any of the filament agar plates for all prepared concentrations of E. coli. After 48 hours of testing there were 0 CFUs on any of the filament agar plates for all prepared concentrations of E. coli. The DE broth showed no color change for all prepared concentrations of E. coli exposed to the filaments after 24 and 48 hours. There were no live bacteria on the surface of any of the filaments that were exposed for 1 hour to E. coli concentrations of the 10⁵, 10⁶ and 10⁷ CFUs. Duplicates of the testing showed the same results.

### Example 4

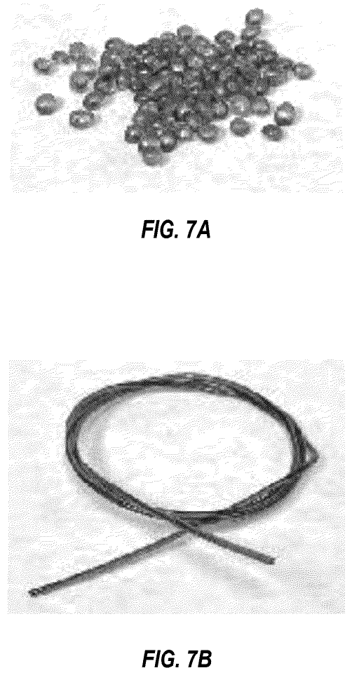

A method was successfully employed to spray industry standard pellets, illustrated in FIG. 7A, with metal nanoparticles dispersed in a volatile solvent, which was removed by evaporation. The treated pellets were extruded through a hot mixer into a filament, as illustrated in FIG. 7B. The filament was cross sectioned with a diamond edge cutter to under 100 nm thickness, after encasing in ECON polymer to protect the filament from damage. Tomed slices of the filament were used for STEM/EDS imaging. The metal nanoparticles were successfully integrated with the plastic and showed an interesting, uniform distribution that was not exclusive with the plastic polymer chains. The nanoparticles appear to be free to move about the plastic if a fluid force and temperature or energy gradient is present.

### Example 5

Spherical-shaped silver nanoparticles made by laser ablation, with no external bond angles or edges, which are nonionic, and which do not release silver ions were tested to determine if they caused silver nanoparticle resistant bacteria. No such resistance was detected after 28 passages.

The study was entitled “Mutant generation testing on P. aeruginosa ATCC 15442, and E. coli ATCC 25922”. Two different types of spherical silver nanoparticles were tested: Silver Lot #Desktop Laser: Ag200917-104 (19 ppm) and Silver Lot #Industrial Laser: 171229-101 (16.8 ppm). The spherical-shaped silver nanoparticles made using the desktop laser had a mean diameter between 8-10 nm, and the spherical-shaped silver nanoparticles made using the industrial laser had a mean diameter between 8-12 nm.

The procedure for the study is outlined as follows:

### Bacteria Preparation:

1. Streak bacteria onto tryptic soy agar (TSA) plates and incubate overnight 37° C.
2. Next day, inoculate 10 mL of silver with Mueller Hinton broth mix with one colony.
   a. Desktop laser:
      i. E. coli-Make a 4.75 ppm silver nanoparticle mix in the broth (2.5 mL Ag+7.5 mL broth).
      ii. P. aeruginosa-Make a 4.75 ppm silver nanoparticle mix in the broth (2.5 mL Ag+7.5 mL broth).
   b. Industrial laser:
      i. E. coli-Make a 2 ppm silver nanoparticle mix in the broth (1.2 mL Ag+8.8 mL broth).
      ii. P. aeruginosa-Make a 2 ppm silver nanoparticle mix in the broth (1.2 mL Ag+8.8 mL broth).
3. Incubate at 37° C. at 250 RPM 24-36 hours.
4. Monitor growth the next day.
5. Continue to serial passage in a new silver broth mixture with an inoculating loop into culture.
6. Every 5-7 days, streak out a loop of culture onto TSA plates to preserve passages then perform an MIC test on colonies to measure if the bacteria have generated resistance to the spherical silver nanoparticles.

The results of the study are as follows:

### MIC Values:

E. coli-Industrial laser sample: MIC held at 2 ppm out to serial passage 28. DT laser sample: Culture stopped regenerating after passage 21. MIC held in previous passages.
P. aeruginosa-Industrial laser sample: MIC held at 2 ppm out to serial passage 28.
   DT laser sample: Culture stopped regenerating after passage 21. MIC held in previous passages.
      All negative and positive controls passed.

### COMPARATIVE EXAMPLE

A similar test to the one described in Example 5 is carried out using conventional silver nanoparticles made using a chemical reduction process. The silver nanoparticles have external bond angles and edges and release silver ions in water. Within 6 passages, anti-silver resistance is apparent from increasing MIC values.

### Example 6

Metal nanoparticles are formed via laser ablation in an isopropyl alcohol carrier. The concentration of nanoparticles in the carrier is subsequently increased to 35 ppm using warm nitrogen gas to evaporate excess solvent. A charge of 400 ml of the carrier and metal nanoparticles is added to a cylinder with surfaces that do not significantly attract nanoparticles (e.g., glass, PTFE, or PET) along with 800 g of PE granules. The cylinder and contents are heated in a vacuum oven to accelerate solvent removal and deposition of metal nanoparticles onto the PE granules. The evaporated solvent is collected in cold traps for optional recycling. Two applications of 400 ml each of the carrier with metal nanoparticles results in PE beads with about 35 mg/kg nanoparticles, assuming essentially complete transfer.

After drying, granules are extruded into filaments. Filaments are ashed and digested for ICP-OES and/or ICP-MS testing to determine final load of nanoparticles on the granules. Filaments are also imaged using STEM with dark field camera to verify nanoparticle distribution on the filaments. Filaments are also tested for prevention of microbial colonization. Granules are then exposed to additional drying and are packaged with desiccant under vacuum for storage or delivery.

### Example 7

Spherical silver nanoparticles are dispersed in 1,4-butanediol at a concentration between 100 ppb and 100 ppm. The 1,4-butanediol silver nanoparticle composition is used in the manufacture of polymer compositions, such as polyurethanes by reaction with isocyanates or polyesters by reaction with diacids. The polyurethanes are initially formed by thermosetting. In some cases, thermoset polyurethanes can also be thermoplastic (i.e., TPUs)

### IX. Additional Terms & Definitions

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about.” When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “medical device”) may also include two or more such referents.

The embodiments disclosed herein should be understood as comprising/including disclosed components, and may therefore include additional components not specifically described. Optionally, the embodiments disclosed herein are essentially free or completely free of components that are not specifically described. That is, non-disclosed components may optionally be completely omitted or essentially omitted from the disclosed embodiments. For example, non-disclosed nanoparticle conjugates or non-disclosed solvents may optionally be completely omitted or essentially omitted from the polymer compositions and/or finished medical products disclosed herein.

An embodiment that “essentially omits” or is “essentially free of” a component may include trace amounts and/or non-functional amounts of the component. For example, an “essentially omitted” component may be included in an amount no more than 2.5%, no more than 1%, no more than 0.1%, or no more than 0.01% by total weight of the composition. This is likewise applicable to other negative modifier phrases such as, but not limited to, “essentially omits,” “essentially without,” similar phrases using “substantially” or other synonyms of “essentially,” and the like.

A composition that “completely omits” or is “completely free of” a component does not include a detectable amount of the component (i.e., does not include an amount above any inherent background signal associated with the testing instrument) when analyzed using standard coating composition analysis techniques such as, for example, chromatographic techniques (e.g., thin-layer chromatography (TLC), gas chromatography (GC), liquid chromatography (LC)), or spectroscopy techniques (e.g., Fourier transform infrared (FTIR) spectroscopy).

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

1. A method of manufacturing a polymer product, comprising:
applying a nanoparticle solution to a polymer composition, the nanoparticle solution comprising nonionic metal nanoparticles formed via laser ablation; and
forming the polymer composition into a polymer product, the metal nanoparticles being incorporated therein.

2. The method of claim 1, wherein the nanoparticle solution comprises a volatile solvent and wherein the polymer composition comprises polymer granules, the method further comprising:
applying the nanoparticle solution to polymer granules;
removing the volatile solvent by evaporation to thereby leave the metal nanoparticles on and/or impregnated in the polymer granules;
heating the polymer granules into a molten polymer to disperse the metal nanoparticles in the molten polymer; and
forming the molten polymer into the polymer product.

3. The method of claim 2, wherein the nanoparticle solution is applied to the polymer granules by adding both the nanoparticle solution and the polymer granules to a container.

4. The method of claim 2, wherein the nanoparticle solution is applied to the polymer granules by spraying the nanoparticle solution onto to the polymer granules.

5. The method of claim 2, wherein the nanoparticle solution is applied to the polymer granules using a centrifuge.

6. The method of claim 1, wherein the nanoparticle solution comprises a volatile solvent and wherein the polymer composition is a liquid polymer composition, the method comprising removing the volatile solvent by evaporation after applying the nanoparticle solution to the polymer composition and before forming the polymer composition into the polymer product.

7. The method of claim 1, wherein the nanoparticle solution comprises a precursor polymer component and wherein the polymer composition is a liquid, the method further comprising mixing the precursor polymer component with the nanoparticle solution.

8. The method of claim 7, wherein the precursor polymer component comprises polyethylene glycol (PEG) or 1,4-butanediol.

9. The method of claim 1, wherein the metal nanoparticles comprise silver nanoparticles.

10. The method of claim 1, wherein the metal nanoparticles comprise gold nanoparticles.

11. The method of claim 1, wherein the metal nanoparticles comprise a combination of gold and silver nanoparticles.

12. The method of claim 11, wherein a ratio of silver nanoparticles to gold nanoparticles is 1:1 to about 50:1, or about 2.5:1 to about 25:1, or about 5:1 to about 20:1, or about 7.5:1 to about 15:1, or about 9:1 to about 11:1, or about 10:1.

13. The method of claim 1, wherein the metal nanoparticles comprise spherical-shaped nanoparticles.

14. The method of claim 1, wherein the spherical-shaped metal nanoparticles have a mean dimeter in a range of about 1 nm to about 40 nm, or about 2 nm to about 20 nm, or about 3 nm to about 14 nm, or about 4 nm to about 13 nm, or about 5 nm to about 12 nm, or about 6 nm to about 10 nm.

15. The method of claim 14, wherein the metal nanoparticles have a particle size distribution wherein at least 99% of the metal nanoparticles have a particle size within 30% of the mean diameter, or within 20% of the mean diameter, or within 10% of the mean diameter and/or wherein at least 99% of the spherical-shaped nanoparticles have a diameter within ±3 nm of the mean diameter, or within ±2 nm of the mean diameter, or within ±1 nm of the mean diameter.

16. The method of claim 1, wherein the metal nanoparticles have a ξ-potential of at least about ±10 mV (absolute value), or at least about ±15 mV, or at least about ±20 mV, or at least about ±25 mV, or at least about ±30 mV.

17. The method of claim 1, wherein the metal nanoparticles comprise coral-shaped nanoparticles.

18. The method of claim 1, wherein the metal nanoparticles comprise both spherical-shaped nanoparticles and coral-shaped nanoparticles, optionally wherein the mass ratio of spherical-shaped nanoparticles to coral-shaped nanoparticles in the nanoparticle solution is 1:1 to 50:1.

19. A polymer product formed by the method of claim 1.

20. A method of manufacturing a polymer product, comprising:
applying a nanoparticle solution to thermoplastic polymer granules, the nanoparticle solution comprising nonionic metal nanoparticles formed via laser ablation and a volatile solvent;
removing the volatile solvent by evaporation to thereby leave the metal nanoparticles on and/or impregnated in the thermoplastic polymer granules;
heating the thermoplastic polymer granules into a molten polymer to disperse the metal nanoparticles in the molten polymer; and
forming the polymer composition into a polymer product, the metal nanoparticles being incorporated therein.

21. A method of manufacturing a thermoset polymer product, comprising:
adding metal nanoparticles to a liquid component of a multi-component thermosetting polymer composition;
mixing multiple components of the thermosetting polymer composition to disperse the metal nanoparticles in the thermosetting polymer composition;
forming the thermosetting polymer composition into a desired shape; and
causing or allowing the thermosetting polymer composition to solidify in the desired shape of the thermoset polymer product, the metal nanoparticles being dispersed in the thermoset polymer product.
